(19) United States
(12) Patent Application Publication
(10) Pub. No.: US 2019/0316547 A1
(43) Pub. Date: Oct. 17, 2019

(54) Water Distributor for an Internal Combustion Engine

(71) Applicant: MANN+HUMMEL GmbH, Ludwigsburg (DE)

(72) Inventors: Alexander Korn, Gueglingen (DE); Helmut Neuschwander, Ludwigsburg (DE)

(21) Appl. No.: 16/383,765

(22) Filed: Apr. 15, 2019

(30) Foreign Application Priority Data
Apr. 13, 2018 (DE) 10 2018 003 025.4

(51) Int. Cl. F02M 25/022; F02M 25/03; F02B 47/02

(52) U.S. Cl. CPC F02M 25/0221; F02M 25/03; F05B 2230/234; F02M 25/0227; F05C 2225/00; F02B 47/02

(57) ABSTRACT

A water distributor for water to be injected into a combustion chamber of an internal combustion engine is provided with a housing that has a receiving chamber, wherein the receiving chamber extends in a longitudinal direction of the housing. An insertion element with an insertion section is provided and the insertion section is inserted into the receiving chamber and extends in the longitudinal direction in correspondence to the receiving chamber. A water inlet and at least one water outlet are provided. A distributor channel connects the water inlet in fluid communication to the at least one water outlet. The distributor channel is delimited at least partially by the insertion element. The housing and the insertion element are connected water-tightly to each other at an end face of the housing. The housing and the insertion element are made a plastic material.

### BACKGROUND OF THE INVENTION

The invention concerns a water distributor for water to be injected into a combustion chamber of an internal combustion engine.

Water injection is employed in internal combustion engines for performance enhancement and emission reduction. The water is injected in addition to the fuel to be combusted into the combustion chambers, for example, the cylinders, of the internal combustion engine. For injecting the water, injectors are used which are supplied by means of a water distributor with the water to be injected. In order to be able to empty the water distributor when shutting off the internal combustion engine, for example, in order to avoid freezing, water-conducting channels within the water distributor must be embodied with a diameter as small as possible of typically maximally 4 mm.

Water distributors that are available on the market comprise in general a stainless steel pipe to which receptacles for the injectors are welded or soldered. Also, holders for fastening the water distributor are welded or soldered to the stainless steel pipe. The receptacles for the injectors and the holders of known water distributors are also comprised of stainless steel. The manufacture of such a water distributor is relatively expensive due to the expenditure for producing the receptacles for the injectors and the holders as well as in particular due to the required joining processes. Moreover, such water distributors, due to the use of stainless steel, are heavy which is contrary to the demands in automotive lightweight construction.

### SUMMARY OF THE INVENTION

It is therefore an object of the invention to provide a water distributor for water to be injected into a combustion chamber of an internal combustion engine that can be produced inexpensively and that comprises a mass as small as possible.

This object is solved by a water distributor of the aforementioned kind, comprising:

a housing with a receiving chamber extending, in particular tapering, in a longitudinal direction;

an insertion element with an insertion section that extends, in particular tapers, in the longitudinal direction in correspondence to the receiving chamber, and that is inserted into the receiving chamber;

a distributor channel through which a water inlet is connected in fluid communication to at least one water outlet, wherein the distributor channel is delimited at least partially by the insertion element, and wherein the housing and the insertion element are connected water-tightly to each other at an end face of the housing, and each are comprised of a plastic material.

Preferred embodiments are disclosed in the dependent claims.

The water distributor according to the invention for water to be injected into a combustion chamber of an internal combustion engine comprises a housing and an insertion element. In the housing, a receiving chamber is provided that extends, in particular tapers, in a longitudinal direction. The insertion element comprises an insertion section that extends, in particular tapers, in the longitudinal direction in correspondence to the receiving chamber. The insertion section is inserted into the receiving chamber. Due to the corresponding tapering of the receiving chamber and of the insertion section, a form-fit contact of the insertion section at the receiving chamber can be achieved across a large surface area. In order to provide for a defined insertion depth, an axial stop between the insertion element and the housing can be provided.

The water distributor comprises moreover a distributor channel by means of which a water inlet is connected in fluid communication with at least one water outlet. Typically, the water distributor has a plurality of water outlets, in particular matched to the number of cylinders of the internal combustion engine or of a cylinder bank of the internal combustion engine. The distributor channel then connects in fluid communication all water outlets of the water distributor to the water inlet. The distributor channel extends preferably in a straight line along or parallel to the longitudinal axis. The distributor channel is at least partially delimited by the insertion element, preferably is delimited immediately thereby. In other words, a wall of the distributor channel is formed at least partially by the insertion element. The distributor channel is delimited by the insertion element preferably partially in circumferential direction, i.e., at least across a portion of its circumference extending transverse to the longitudinal axis.

The housing and the insertion element are water-tightly connected to each other at an end face of the housing. Typically, the water-tight connection, in viewing direction along the longitudinal axis, surrounds the distributor channel in an annular shape. Since the water-tight connection is embodied at the end face, it can be embodied particularly short. In this way, the water tightness can be configured particularly easily. The water-tight connection can seal a radial or axial sealing gap between the housing and the insertion element, preferably in that the sealing gap is filled by material fusion of the housing and the insertion element. The housing can have elements at the end face that project past the water-tight connection.

The housing and the insertion element are comprised of plastic material, respectively. The plastic material may contain fillers, for example, fibers for reinforcing or particles for obtaining certain properties. Inserts comprised of a metallic or ceramic material can be embedded in the plastic material. By using a plastic material, a significant weight reduction is achieved in comparison to conventional water distributors of stainless steel.

The multi-part configuration of the water distributor in accordance with the invention comprising the housing and the insertion element makes it possible to manufacture the water distributor from the plastic material.

Because of the required stability and cooling devices required for an elongate core in a plastic injection molding tool for forming an elongate cavity, a certain ratio of diameter to length of a core cannot be undershot. By means of the multi-part configuration of the water distributor in accordance with the invention, it is however possible to form a distributor channel with a diameter that is small relative to its length in a stable housing of plastic material.

For a four-cylinder in-line engine or a cylinder bank of a V8-cylinder engine, the length of the distributor channel is typically approximately 300 mm. In order to enable complete emptying of the water distributor when shutting off the internal combustion engine, for example, by direction reversal of a connected water pump, the distributor channel must have a minimal cross-sectional surface. In principle, the cross-sectional surface of the distributor channel amounts to at most 20 mm², preferably at most 15 mm5, particularly preferred at most 13 mm². Correspondingly, an inner diameter of the distributor channel amounts to at most 4 mm. Up to now, such a long and thin distributor channel cannot be produced economically in a one-piece water distributor of plastic material. By providing the insertion element, the receiving chamber of the housing can be embodied with a greater diameter so that it can be manufactured easily, in particular by an injection molding process. By interaction of housing and insertion element, the distributor channel with the required dimensions is obtained.

The configuration of the water distributor according to the invention provides that the water-tight connection is to be configured at the end face of the housing. Here, the connection must only be provided across a very short stretch in a water-tight embodiment. In this way, a permanent water tightness can be ensured particularly reliably. In operation of the water distributor, the latter is loaded with a water pressure of typically approximately 10 bar. In this context, the tensions that are produced by the operating pressure in longitudinal direction are smaller than the tensions acting in the circumferential direction. The water-tight connection is thus only minimally mechanically loaded.

It should be noted that minimal gaps may be provided between the insertion element and the housing as well as possibly between separate parts, for example, half shells, of the insertion element. In other words, it is not required that the distributor channel—aside from the water inlet and transitions to the water outlets or optionally to a pressure sensor—must be water-tight in itself. Water can penetrate into the gaps but, due to the minimal gap width, only minimal volume expansions occur when water freezes in the gaps. Therefore, the forces that are exerted on the water distributor by the frozen water in the gaps are low. The water-tight connection at the end face provided in accordance with the invention ensures the required water tightness for the operation of the water distributor.

The distributor channel, on the one hand, can be delimited by the insertion element and, on the other hand, by the housing. The insertion element can be designed and manufactured in a particularly simple way. The boundary of the distributor channel is typically embodied to be divided in longitudinal direction. Preferably, in the housing and in the insertion element a longitudinal groove is formed, respectively, wherein the two longitudinal grooves together form the distributor channel. Preferably, the two longitudinal grooves have the same depth, respectively, in particular across the entire length of the distributor channel. In this way, a symmetrical length division of the distributor channel is achieved. A contact surface between the housing and the insertion element that intersects the distributor channel can be planar. In this way, a uniform contact pressure of the insertion section at the housing within the contact surface can be obtained. A planar contact surface can also be designed so as to be in contact with the distributor channel. The distributor channel is then formed by a depression provided in the insertion element or in the housing and extending along the longitudinal direction and closed off at one side by the planar contact surface of the other component.

In an alternative embodiment of the invention, the distributor channel is completely delimited by the insertion element. In this case, the housing, in particular its receiving chamber, can be designed and manufactured particularly easily.

Preferably, the insertion section of the insertion element comprises two half shells. In the half shells, a longitudinal groove can be formed, respectively, wherein the two longitudinal grooves together form the distributor channel. The distributor channel is thus designed divided in length direction wherein one respective side of the distributor channel is delimited by one of the two half shells, respectively. Preferably, the two longitudinal grooves are embodied to each have the same depth, in particular across the entire length of the distributor channel. In this way, a symmetrical length division of the distributor channel is obtained. The two half shells can be connected to each other in accordance with the invention by a film hinge. Such a film hinge can be directly integrally formed at the components during injection molding. This facilitates handling of the insertion element and its installation in the housing. In an alternative embodiment, a longitudinal groove is formed only at one of the half shells. One side of the distributor channel is thus delimited by the half shell with longitudinal groove while the other side of the distributor channel is delimited by the other half shell. The boundary provided by the other half shell is typically planar.

The housing and the insertion element can be welded together at the end face, preferably by a laser welding method. By welding, the connection of the insertion element with the housing can be embodied to be water-tight and mechanically stable. Preferably, a continuous, circumferentially extending inner weld seam and an outer weld seam, preferably continuous and circumferentially extending, are provided spaced apart from each other at the end face. The inner weld seam can ensure the water-tight connection of the housing and of the insertion element. The outer weld seam can ensure the mechanical strength of the connection. The outer weld seam then does not come into contact with the water. In this way, it can be achieved that the mechanical stability is ensured across a long period of time because there is the risk that the inner weld seam over time will slowly decompose or be weakened due to the contact with water. The inner weld seam therefore acts as a sacrificial seam. When the outer weld seam is also continuously extending in circumferential direction, the water tightness of the connection remains intact even after failure of the inner weld seam. The service life of the water distributor can thus be significantly improved.

The distributor channel can have a circular cross section with a diameter of at most 4.5 mm, preferably at most 4.0 mm. A circular cross section is beneficial with regard to fluid mechanics. The minimal diameter facilitates the complete emptying of the water distributor when the latter is not in operation. As an alternative to the circular cross section, the distributor channel can have a non-circular cross section, for example, a semicircular, a triangular or a rectangular, in particular square, cross section.

Preferably, the distributor channel has a constant cross section across its entire length. The cross section of the distributor channel then does not taper along its longitudinal direction.

The water inlet can be embodied at the insertion element. The water inlet comprises usually a connector channel that opens into the distributor channel. By means of the water inlet at the insertion element, in a constructively simple way a flow-beneficial, in particular dead space-free, transition from the connector channel into the distributor channel can be obtained. Alternatively, the water inlet can be provided at the housing, in particular at the end of the housing that is opposite the end face with the water-tight connection.

In the insertion element, a passage can be formed which connects in fluid communication the distributor channel to the water outlet. Optionally, in the insertion element a passage for each water outlet can be formed, wherein the passage connects the distributor channel to the respective water outlet. This facilitates the flow guidance in particular in case of a distributor channel that is completely delimited by the insertion element.

Preferably, a sensor connector for a pressure sensor is formed, in particular integrally formed, at the housing. The pressure sensor can transmit the level of the water pressure in the water distributor to a control device of the internal combustion engine. In the insertion element preferably an opening is formed which connects in fluid communication the distributor channel to the sensor connector. This can reduce the pressure loss between the distributor channel and the pressure sensor in a simple way with respect to construction and manufacturing technology so that a precise pressure measurement is enabled.

Advantageously, an inner contour of the receiving chamber of the housing and an outer contour of the insertion section of the insertion element are embodied in the shape of a segment of a circle, in particular semi-circular. In this way, a uniform contact pressure of the outer contour of the insertion section at the inner contour of the receiving chamber can be effected even when the housing and the insertion element are manufactured with certain tolerances.

Preferably, the receiving chamber of the housing and the insertion section of the insertion element taper uniformly in the longitudinal direction. This can contribute to an at least approximately constant contact pressure relative to each other in the longitudinal direction. Moreover, the insertion depth can be varied within a certain range in order to adjust a desired orientation of housing and insertion element relative to each other or in order to insert the insertion element until it meets an axial stop at the housing.

Optionally, at the end face of the water distributor that is opposite the end face with the water-tight connection of the insertion element and of the housing, a cover can fluid-tightly close off an opening in the housing. This opening may be required, in particular in case of water distributors of great length, in order to support, during the manufacture of the housing by the injection molding method, the tool, for example, a core which forms the cavity during the injection molding process, at the end face which is opposite the inlet side. The cover can be seal-tightly fastened to the housing in the same way as the insertion element. The water inlet of the water distributor can be formed at the insertion element or at the cover. The cover is typically also comprised of a plastic material, in particular the same plastic material as the housing and/or the insertion element.

Preferably, the housing and the insertion element are produced from the same plastic material. Thermally caused size changes then occur at both components to the same degree so that thermally induced mechanical tensions can be substantially avoided. Also, a thermally induced spreading of gaps in the interior of the water distributor can be avoided in this way.

The plastic material can be polypropylene and/or polyamide. Polypropylene is particularly preferred because it exhibits a particularly minimal water absorption and water permeability. Polyamide can be advantageous with regard to strength considerations.

The plastic material can comprise a fiber-reinforced, in particular glass fiber-reinforced, plastic material. In this way, the mechanical load stability of the water distributor can be increased. Preferably, short fibers that are distributed randomly in the plastic matrix are employed for reinforcement. They can be simply processed also during injection molding. For a greater strength, fibers oriented in a targeted fashion, in particular long fibers, can be employed at particularly stressed locations, for example, in the region of the end face of the housing, at the water inlet, at the water outlet, at a sensor connector and/or in the region of holders which may be integrally formed at the housing.

### BRIEF DESCRIPTION OF THE DRAWINGS

Further features and advantages of the invention result from the following detailed description of embodiments of the invention, from the claims as well as from the Figures of the drawing which show details important to the invention. The different features can be realized each individually or several combined in any combination in variants of the invention. The features illustrated in the drawing are illustrated such that the particularities according to the invention can be shown particularly well.

FIG. 1 shows a water distributor according to the invention in a first embodiment in a perspective view at a slant from above.

FIG. 2 shows a schematic longitudinal section of the water distributor of FIG. 1, wherein the configuration of the water distributor of a housing and of an insertion element received in the housing can be seen.

FIG. 3a shows the water distributor of FIG. 1 in an exploded illustration in viewing direction at a slant from below, wherein an insertion section of the insertion element is illustrated outside of a receiving chamber of the housing.

FIG. 3b shows an enlarged perspective illustration of an end face of the housing in a view as in FIG. 3a, but without insertion element.

FIG. 4 shows a schematic cross section at section line F4 of the water distributor of FIG. 1, sectioned at the level of a sensor connector.

FIG. 5 shows a schematic cross section at section line F5 of the water distributor of FIG. 1, sectioned at the level of a water outlet.

FIG. 6 shows a water distributor according to the invention in a second embodiment in a schematic longitudinal section.

FIG. 7 shows a schematic cross section at section line F7 of the water distributor of FIG. 6, sectioned at the level of a sensor connector.

FIG. 8 shows a schematic cross section at section line F8 of the water distributor of FIG. 6, sectioned at the level of a water outlet.

FIG. 9 shows the insertion element of the water distributor of FIG. 6 with folded-apart half shells which are connected to each other by a film hinge.

FIG. 10 shows an insertion element for a water distributor according to the invention, wherein an insertion section of the insertion element comprises two half shells that can be plugged into each other.

### DESCRIPTION OF PREFERRED EMBODIMENTS

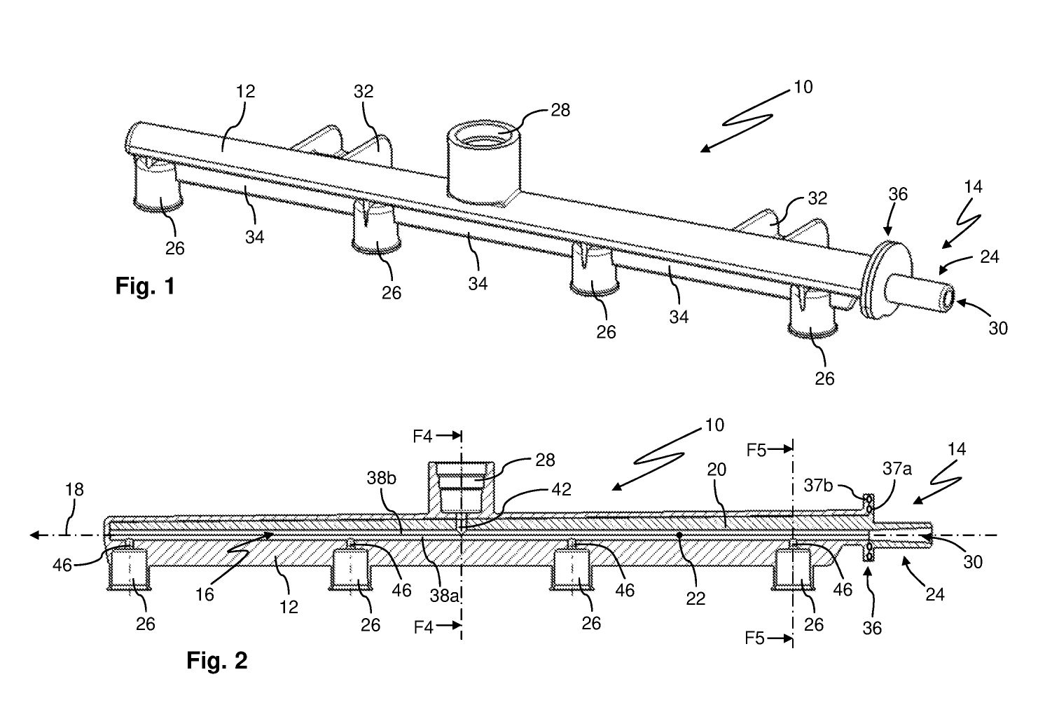

FIG. 1 shows a water distributor 10 according to the invention in a first embodiment in a perspective view at a slant from above. In FIG. 2, the water distributor 10 is illustrated in longitudinal section.

The water distributor 10 comprises a housing 12 and an insertion element 14. The housing 12 and the insertion element 14 are comprised here of the same plastic material, i.e., a glass fiber-reinforced polypropylene. A receiving chamber 16 is embodied in the housing 10. The receiving chamber 16 tapers in a longitudinal direction 18. Here, the receiving chamber 16 tapers along the longitudinal direction 18 uniformly, i.e., with a constant rate of decrease of its inner diameter. The insertion element 14 comprises an insertion section 20. The insertion section 20 is received in the receiving chamber 16, i.e., is inserted into it. The insertion section 20 tapers in the longitudinal direction in correspondence to the receiving chamber 16, here uniformly.

A distributor channel 22 is embodied in the water distributor 10. The distributor channel 22 extends here along the longitudinal direction 18. The water distributor 10 comprises a water inlet 24 and four water outlets 26. Moreover, the water distributor 10 comprises a sensor connector 28.

The water inlet 24 is embodied at the insertion element 14. A connecting channel 30 extends through the water inlet 24 and opens into the distributor channel 22. The water inlet 24 is connectable to a water supply, for example, a water hose (not illustrated).

The water outlets 26 and the sensor connector 28 are formed as one piece together with the housing 12 of the water distributor 10, here integrally formed thereon. Also, two holders 32 for fastening the water distributor 10 are integrally formed on the housing 12. Reinforcement ribs 34 are extending between the water outlets 26.

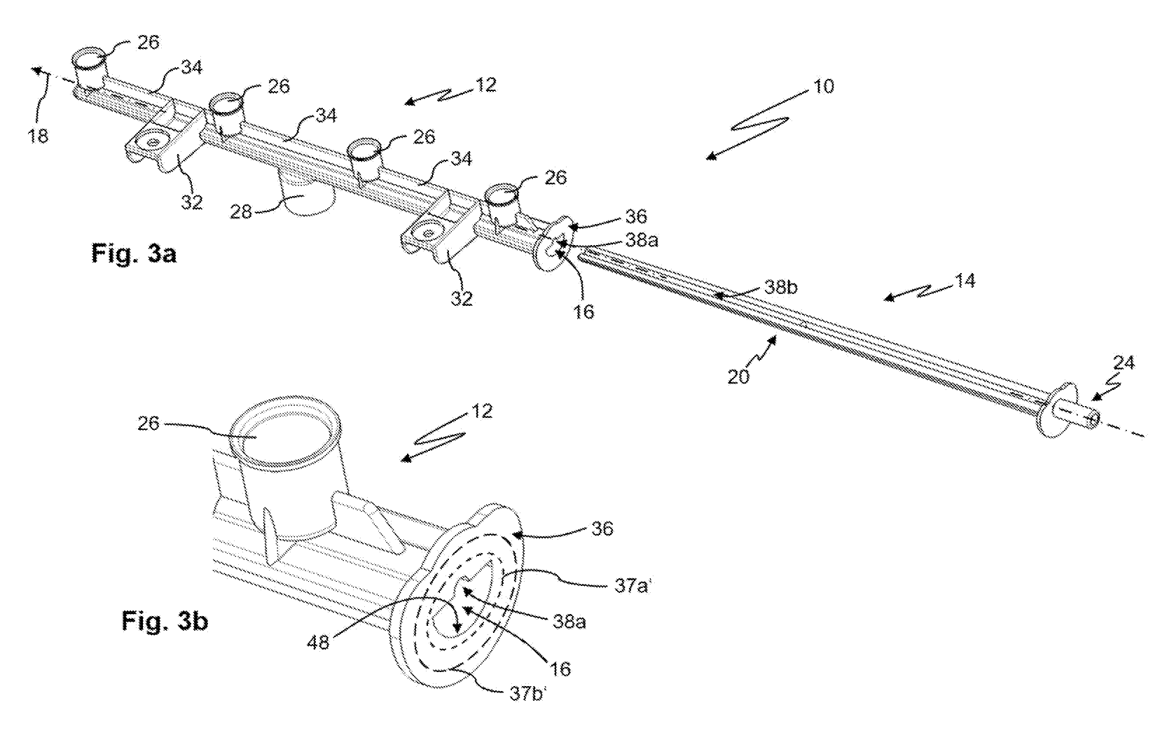

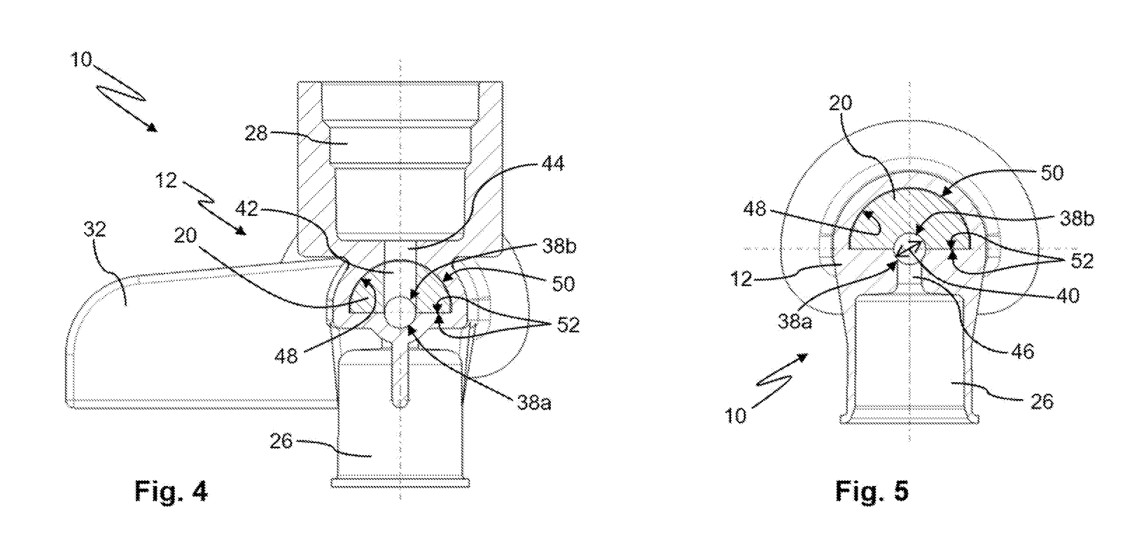

For a detailed explanation of the distributor channel 22 of the connection of the housing 12 to the insertion element 14, reference is additionally being had to FIG. 3a and FIG. 3b as well as FIG. 4 and FIG. 5. FIG. 3a shows an exploded illustration of the water distributor 10 viewed from below at a slant. FIG. 3b shows an enlarged detail of the housing 12 with a view of an end face 36 from where the receiving chamber 16 is extending away. FIG. 4 shows a cross section of the water distributor 10 at the level of the sensor connector 28 in viewing direction opposite to the longitudinal direction 18. In FIG. 5, a cross section of the water distributor 10 at the level of a water outlet 26 is illustrated, also in viewing direction opposite to the longitudinal direction 18.

At the end face 36, the housing 12 is connected water-tightly to the insertion element 14. The connection comprises here an inner weld seam 37a and an outer weld seam 37b. In FIG. 3b, it is indicated by dashed lines 37a=, 37b= that the weld seams 37a and 37b are arranged continuously in circumferential direction about the receiving chamber 16. Therefore, the weld seams 37a, 37b also surround the distributor channel 22 completely in viewing direction along the longitudinal direction 18. The weld seams 37a and 37b are spaced apart from each other at the end face 36. The inner weld seam 37a ensures that the connection of the housing 12 with insertion element 14 is water-tight. The outer weld seam 37b ensures the required mechanical strength. Both weld seams 37a, 37b have been produced by means of a laser welding method.

The distributor channel 22 is formed by two longitudinal grooves 38a, 38b. The longitudinal groove 38a extends straight in the housing 12; the longitudinal groove 38b extends straight in the insertion section 20 of the insertion element 14. Across the first half of its circumference, the distributor channel 22 is delimited by the housing 12 by the longitudinal groove 38a. Across the second half of its circumference, the distributor channel 22 is delimited by the insertion element 14 by the longitudinal groove 38b. Therefore, the insertion element 14 partially delimits the distributor channel 22 in circumferential direction.

The longitudinal grooves 38a, 38b here are embodied semi-circular with a constant mutually identical depth along the longitudinal direction 18. In the mounted state of the water distributor 10, a circular cross section of the distributor channel 22 results in this way; see in particular also FIG. 4 and FIG. 5. A diameter 40 of the distributor channel 22 amounts here to 3.8 mm across its entire length. The connecting channel 30 of the water inlet 24 passes continuously into the longitudinal groove 38b of the insertion element 14.

Below the sensor connector 28, the insertion section 20 of the insertion element 14 has an opening 42; see FIG. 4. Through the opening 42, the distributor channel 22 is connected in fluid communication with a passage cutout 44 of the sensor connector 28. Via the passage cutout 44 and the opening 42, the sensor connector 28 opens toward the distributor channel 22. The water pressure existing in the distributor channel 22 is thus acting also on a pressure sensor (not illustrated) fastened at the sensor connector 28.

As can be seen in FIGS. 2 and 5, the distributor channel 22 opens by means of an outlet cutout 46 in the housing 12 toward the water outlets 26, respectively. The outlet cutouts 46 connect the distributor channel 22 in fluid communication to the water outlets 26. Water injectors (not illustrated) fastenable in the water outlets 26 can thus be supplied through the distributor channel 22 with water that is supplied to the water distributor 10 through the water inlet 24. By means of the water injectors, the water can be injected from the water distributor 10 into air inlet channels, for example, into intake channels, of an internal combustion engine. From there, the water together with the intake air passes into the combustion chambers of the internal combustion engine.

The receiving chamber 16 of the water distributor 10 comprises in the illustrated embodiment an inner contour 48 in the form of a segment of a circle. An outer contour 50 of the insertion section 20 of the insertion element 14 is embodied in the shape of a corresponding segment of a circle. This shape of the inner contour 48 and of the outer contour 50 is maintained across the length of the receiving chamber 16 or the insertion section 20. In order to realize the tapering, the radius of the inner contour 48 and of the outer contour 50 decreases however along the longitudinal direction 18. In regions adjoining the longitudinal grooves 38a, 38b, the receiving chamber 16 and the insertion section 20 are planar, respectively, so that a planar contact surface 52 is formed which intersects, here centrally, the distributor channel 22.

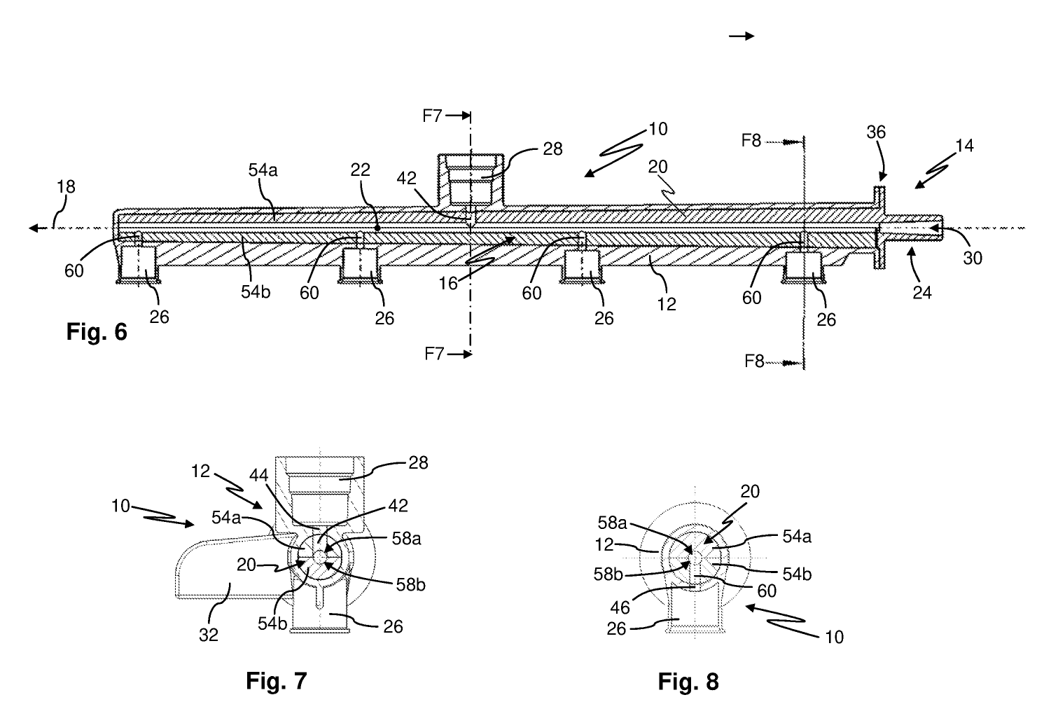

FIG. 6 shows a schematic longitudinal section through a water distributor 10 according to the invention in a second embodiment. The water distributor 10 comprises a housing 12 and an insertion element 14. An insertion section 20 of the insertion element 14 is received in the receiving chamber 16 of the housing 12. In this embodiment, the housing 12 is comprised, for example, of fiber-reinforced polyamide; the insertion element 14 can be manufactured, for example, of (unreinforced) polypropylene. At an end face 36, the housing 12 is water-tightly glued to the insertion element 14. The housing 12 and the insertion element 14 can also be comprised of the same plastic material.

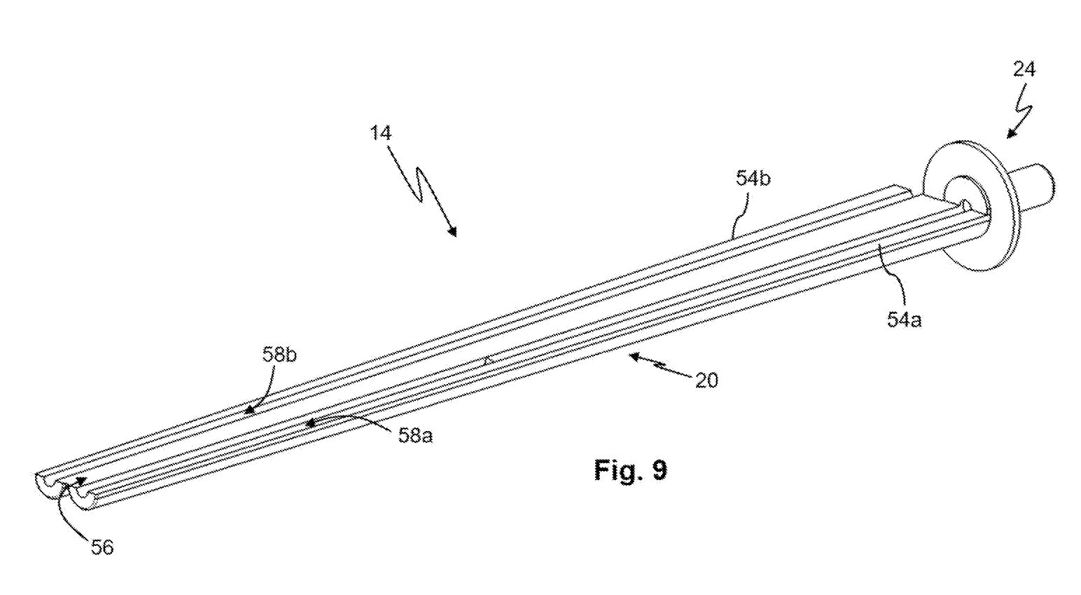

FIG. 7 shows a cross section of the water distributor 10 at the level of the sensor connector 28. FIG. 8 shows a cross section of the water distributor 10 at the level of a water outlet 26. In the following, primarily the differences to the first embodiment of the water distributor, illustrated in FIGS. 1 through 5, will be described.

The insertion section 20 tapers conically in longitudinal direction 18. The insertion section 20 comprises here a round outer contour. Correspondingly, the receiving chamber 16 is embodied with a round cross section which decreases constantly in the longitudinal direction 18 so that also the receiving chamber 16 tapers conically in the longitudinal direction 18.

In this embodiment of the water distributor 10, the insertion section 20 of the insertion element 14 comprises two half shells 54a, 54b. In FIG. 9, the insertion element 14 is illustrated with opened half shells 54a, 54b. The half shells 54a, 54b are connected to each other by a film hinge 56. The film hinge 56 extends here across the entire length of the insertion section 20 but, in an alternative embodiment, can also be embodied only across partial regions. In the receiving chamber 16, a recess (not illustrated here in detail) extending in the longitudinal direction 18 can be formed in order to receive the film hinge 56 of the folded insertion section 20.

In the two half shells 54a, 54b, two longitudinal grooves 58a, 58b, here of the same depth, are provided which in the folded state of the insertion section 20 form a distributor channel 22. The distributor channel 22 is thus completely delimited, in other words completely about the circumference, by the insertion element 14. In the half shell 54a an opening 42 is formed which connects in fluid communication the distributor channel 22 to a sensor connector 28. In the half shell 58a, four passages 60 are formed, each connecting in fluid communication the distributor channel 22 to a water outlet 26. The water outlets 26 comprise for this purpose an outlet cutout 46 which opens into one of the passages 60, respectively.

In order to ensure that the passages 60 and the opening 42 each open into the water outlets 26 or the sensor connector 28, in a further embodiment, not illustrated, an outer shape that has no rotational symmetry and enables a visual or tactile control of the alignment of housing 12 and insertion element 14 relative to each other can be provided at the end face at the housing 12 and at the water inlet 24 of the insertion element 14. Alternatively, the insertion section 20 and the receiving chamber 16 can be provided with a non-round, for example, oval or triangle-like contour. As a further alternative, at the open or at the closed end of the housing 12 and in a corresponding region of the insertion element 14, intermeshing elements can be provided which enable a complete insertion of the insertion element 14 into the housing 12 only in the correct alignment.

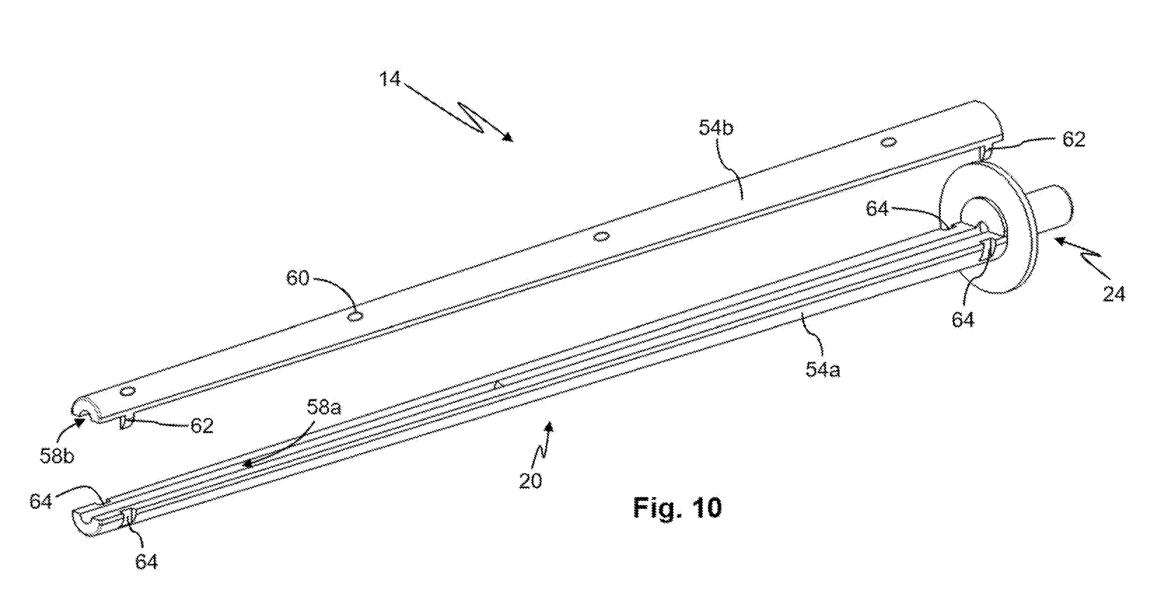

FIG. 10 shows an insertion element 14 of a water distributor according to the invention. The insertion element 14 of FIG. 10 is an alternative configuration to the insertion element according to FIG. 9. It can be inserted into a housing 12 shown in FIG. 8. An insertion section 20 of the insertion element 14 comprises two half shells 54a, 54b in which a longitudinal groove 58a, 58b is formed, respectively. In FIG. 10, the insertion element 14 is shown in an open state. In a closed state, the two longitudinal grooves 58a, 58b form a distributor channel. In the insertion element 14 according to FIG. 10, the two half shells 54a, 54b are embodied as two separate components. At the half shell 54b, projections 62 are formed. The half shell 54a comprises recesses 64. When joining the two half shells 54a, 54b, the projections 62 engage the recesses 64. In this way, the half shells 54a, 54b are guided relative to each other so that, upon insertion into a receiving chamber of a housing, they are pressed against each other in the receiving chamber by a wedging action of the tapering insertion section 20. An additional joining, for example, material-fusing, of the half shells 54a, 54b prior to installation in the housing is not required.

For simple handling of the half shells 54a, 54b and a simple installation in the housing, the recesses 64 and the projections 62 can be designed in the form of a clip connection. Alternatively, the half shells 54a, 54b can be glued together or welded together prior to installation.

What is claimed is:

1. A water distributor for water to be injected into a combustion chamber of an internal combustion engine, the water distributor comprising:
a housing comprising a receiving chamber, wherein the receiving chamber extends in a longitudinal direction of the housing;
an insertion element comprising an insertion section, wherein the insertion section is inserted into the receiving chamber and extends in the longitudinal direction in correspondence to the receiving chamber;
a water inlet and at least one water outlet;
a distributor channel connecting the water inlet in fluid communication to the at least one water outlet, wherein the distributor channel is delimited at least partially by the insertion element;
wherein the housing and the insertion element are connected water-tightly to each other at an end face of the housing;
wherein the housing and the insertion element each are comprised of a plastic material.

2. The water distributor according to claim 1, wherein the distributor channel is delimited by the insertion element and is further delimited by the housing.

3. The water distributor according to claim 2, wherein the housing comprises a first longitudinal groove and the insertion element comprises a second longitudinal groove, wherein the first and second longitudinal grooves together form the distributor channel.

4. The water distributor according to claim 3, wherein the first and second longitudinal grooves have the same depth.

5. The water distributor according to claim 2, wherein a contact surface between the housing and the insertion element intersects the distributor channel and is planar.

6. The water distributor according to claim 1, wherein the distributor channel is completely delimited by the insertion element.

7. The water distributor according to claim 6, wherein the insertion section of the insertion element comprises a first half shell comprising a first longitudinal groove and further comprises a second half shell comprising a second longitudinal groove, wherein the first and second longitudinal grooves form together the distributor channel.

8. The water distributor according to claim 7, wherein the first and second longitudinal grooves have the same depth.

9. The water distributor according to claim 6, wherein the two half shells, at least in sections thereof, are connected to each other by a film hinge.

10. The water distributor according to claim 1, wherein the housing and the insertion element are welded together at the end face.

11. The water distributor according to claim 10, wherein the housing and the insertion element are welded together at the end face by laser welding.

12. The water distributor according to claim 10, wherein at the end face a continuous, circumferentially extending inner weld seam and an outer weld seam are provided spaced apart from each other.

13. The water distributor according to claim 12, wherein the outer weld seam is a continuous, circumferentially extending weld seam.

14. The water distributor according to claim 1, wherein the distributor channel has a circular cross section with a diameter of at most 4.5 mm.

15. The water distributor according to claim 1, wherein the distributor channel comprises a constant cross section across an entire length thereof.

16. The water distributor according to claim 1, wherein the water inlet is embodied at the insertion element.

17. The water distributor according to claim 1, wherein the insertion element comprises a passage connecting in fluid communication the distributor channel to the at least one water outlet.

18. The water distributor according to claim 1, wherein the housing comprises a sensor connector configured to receive a pressure sensor and wherein the insertion element comprises an opening connecting the distributor channel to the sensor connector in fluid communication.

19. The water distributor according to claim 1, wherein an inner contour of the receiving chamber of the housing and an outer contour of the insertion section of the insertion element each comprise a shape of a segment of a circle.

20. The water distributor according to claim 19, wherein the shape of the outer contour and of the inner contour is semi-circular.

21. The water distributor according to claim 1, wherein the insertion section and the receiving chamber taper in the longitudinal direction.

22. The water distributor according to claim 21, wherein the receiving chamber and the insertion section taper uniformly in the longitudinal direction.

23. The water distributor according to claim 1, wherein the housing and the insertion element are made of the same plastic material.
